(19) United States
(12) Patent Application Publication
(10) Pub. No.: US 2008/0080469 A1
(43) Pub. Date: Apr. 3, 2008

(54) Method and apparatus for reporting in a communication network

(75) Inventors: Troels Kolding, Klarup (DK); Frank Frederiksen, Klarup (DK)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/906,109

(22) Filed: Sep. 28, 2007

Related U.S. Application Data
(60) Provisional application No. 60/849,151, filed on Oct. 2, 2006.

(51) Int. Cl. H04B 7/216

(52) U.S. Cl. 370/342

(57) ABSTRACT

In accordance with exemplary embodiments of the present invention a method, apparatuses and system are provided that may facilitate adaptiveness in channel quality reporting while limiting signaling overhead. The invention may include an adapter for setting the thresholds, boundaries or range of channel quality indices that are to be included in a report from a cell or user equipment terminal served by a network element, such as a Node B or an evolved Node B. The report provides an indication of the channel quality experienced by the cell or user equipment. The invention may also include determiner for selecting a number of channel quality indices to include in the report. The number of channel quality indices included may be based at least on the range selected by the network element, or may also be based on an observed scheduling history of the cell or user equipment terminal.

### CROSS REFERENCE TO RELATED APPLICATIONS

This application claims the benefit of U.S. Provisional Application No. 60/849,151, filed Oct. 2, 2006.

### FIELD OF THE INVENTION

The present invention pertains to the field of telecommunications. More particularly, the present invention relates to the reporting of channel quality indicators in a wireless communication system.

### BACKGROUND OF THE INVENTION

The present invention involves the long term evolution (LTE) of 3GPP.

Implementations of wireless communication systems, such as UMTS (Universal Mobile Telecommunication System), each include a radio access network (RAN). In UMTS, the RAN is called UTRAN (UMTS Terrestrial RAN). Of interest to the present invention is an aspect of LTE referred to as “evolved UMTS Terrestrial Radio Access Network,” or E-UTRAN. In general, in E-UTRAN resources are assigned more or less temporarily by the network to one or more user equipment terminals (UE) by use of allocation tables, or more generally by use of a downlink resource assignment channel. Users are generally scheduled on a shared channel every transmission time interval (TTI) by a Node B or an evolved Node B (eNode B). In order to facilitate the scheduling on the shared channel, the eNode B transmits an allocation in a downlink control channel to the UE. The allocation information may be related to both uplink and downlink channels. The allocation information may include information about which resource blocks in the frequency domain are allocated to the scheduled user(s), which modulation and coding schemes to use, what the transport block size is, and the like.

In general, E-UTRAN may use orthogonal frequency division multiplexing (OFDM) as the multiplexing technique for a downlink connection between the e-Node B and the UE terminal, in which different system bandwidths from 1.25 MHz to 20 MHz are applied. Using OFDM may allow for link adaptation and user multiplexing in the frequency domain. However, to utilize the potential of multiplexing in the frequency domain the Node B or eNode B needs to have information related to the instantaneous channel quality. In order for the Node B or eNode B to be informed of the channel quality, the user equipment terminal provides channel quality indicator (CQI) reports to the eNode B. The user equipment terminal may periodically, or in response to a particular event send CQI reports to the respective serving eNode B, which indicate the recommended transmission format for the next transmission time interval (TTI). The report may be constructed in such a way that it indicates the expected supported transport block size under certain assumptions, which may include, the recommended number of physical resource blocks (PRB), the supported modulation and coding scheme, the recommended multiple input multiple output (MIMO) configuration, as well as a possible power offset.

The CQI reports are used for resource scheduling and adaptive modulation and coding. The eNodeB typically assigns user equipment resources based on their respective channel qualities as indicated by the CQI reports. User equipment are also assigned a code rate and modulation format based on channel quality. The eNodeB typically attempts to adapt to the current channel conditions of a user equipment by selecting the highest possible modulation and coding scheme that will keep the frame error probability below a certain threshold, for example 10% in High Speed Downlink Packet Access (HSDPA).

One approach for transmitting CQI reports from the user equipment to the NodeB or eNodeB is the so called best-M method, in which each user equipment reports indications for a number (equal to a set value of M) of sub-bands with the best channel quality. Optimally, the number of best channel quality sub-bands to include in a CQI report is dynamically dependent upon the conditions of the cell or user equipment; e.g. this may change rapidly on a per-scheduling interval basis, i.e. 0.5-1 ms in E-UTRAN. Furthermore, providing an update on the number of sub-bands to include in the CQI report requires signaling between the Node-B and the user equipment, which may result in errors and reduces the available capacity. What is needed is a framework that is capable of reducing the signaling load while facilitating a fast response to the current operating conditions of the user and/or the cell.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with a first aspect of the invention, a method is provided that includes observing at least one uplink channel condition, and setting a numerical range, based at least on the at least one observed uplink channel condition, of a number of subband indices for inclusion in a report.

In accordance with the first aspect of the invention, the method may also include transmitting the numerical range to at least one user equipment terminal.

In accordance with the first aspect of the invention, the method may also include receiving the report including the number of subband indices from at least one user equipment terminal, and scheduling at least one packet for transmission in response to the report.

In accordance with the first aspect of the invention, the observed uplink channel condition is an uplink channel capacity, and the method further includes decreasing an upper limit of the numerical range when the uplink channel capacity is limited.

In accordance with the first aspect of the invention, the observed uplink channel condition is a number of user equipment terminals available for scheduling, and the method further includes decreasing an upper limit of the numerical range when the number of users available for scheduling exceeds a threshold.

In accordance with the first aspect of the invention, the observed uplink channel condition is a number of multiplexed user equipment terminals, and the method further includes increasing a lower limit of the numerical range when the number of multiplexed user equipment terminals is less than a threshold.

In accordance with the first aspect of the invention, the at least one observed uplink channel condition includes at least one channel condition for at least one user equipment terminal within a cell.

In accordance with the first aspect of the invention, observing at least one channel condition, and setting the numerical range occur in a network element.

In accord with the first aspect of the invention, the number of subband indices to include in the report may include the subband indices for the subbands with the best channel quality of the total available subbands.

In accordance with a second aspect of the invention, a method is provided that includes receiving information related to a numerical range based at least on at least one uplink channel condition, and selecting a number of subband indices to include in a report based at least on the numerical range.

In accordance with the second aspect of the invention, the method also includes providing the report for transmission to a network element.

In accordance with the second aspect of the invention, receiving information related to the numerical range and selecting the number of subband indices occur in a user equipment terminal.

In accordance with the second aspect of the invention, selecting the number of subband indices to include in the report is further based on a number of resource blocks allocated, to the user equipment terminal.

In accordance with the second aspect of the invention, selecting the number of subband indices to include in the report is further based on an available power level for the user equipment terminal.

In accordance with the second aspect of the invention, selecting the number of subband indices to include in the report is further based an uplink traffic load.

In accordance with a third aspect of the invention, an apparatus is provided that includes an observation unit for observing at least one uplink channel condition, and an adapter for setting a numerical range, based at least on the at least one observed uplink channel condition, of a number of subband indices for inclusion in a report.

In accordance with the third aspect of the invention, the apparatus may also include an interface for transmitting the numerical range to at least one user equipment terminal.

In accordance with the third aspect of the invention, the apparatus may also include a scheduler responsive to the report including the number of subband indices, for scheduling at least one packet for transmission in response to the report.

In accordance with the third aspect of the invention, the observed uplink channel condition is an uplink channel capacity, and the adapter is configured to decrease an upper limit of the numerical range when the uplink channel capacity is limited.

In accordance with the third aspect of the invention, the apparatus is or is part of a network element, such as a NodeB or eNodeB.

In accordance with a fourth aspect of the invention, an apparatus is provided that includes a receiver for receiving information related to a numerical range based at least on at least one uplink channel condition, and a determiner for selecting a number of subband indices to include in a report based at least one the numerical range.

In accordance with the fourth aspect of the invention, the apparatus may also include a generator for generating the report using the number of subband indices.

In accordance with the fourth aspect of the invention, the apparatus may be or may be included in a user equipment terminal.

In accordance with a fifth aspect of the invention, a system is provided that includes a network element including an adapter for setting a numerical range, based at least on at least one uplink channel condition, for a number of subband indices for inclusion in a report, and a transmitter for transmitting the numerical range from the network element to at least one user equipment terminal. The user equipment terminal includes a determiner for selecting the number of subband indices to include in the report based at least on the numerical range for a number of subband indices, and a generator for generating the report using the number of subband indices.

In accordance with a sixth aspect of the invention, a computer program product is provided that includes a computer readable storage structure embodying computer program code thereon for execution by a computer processor, wherein the computer program code comprises instructions for performing a method including the steps of observing at least one uplink channel condition, and setting a numerical range, based at least on the at least one observed uplink channel condition, of a number of subband indices for inclusion in a report.

In accordance with a seventh aspect of the invention, a computer program product is provided that includes a computer readable storage structure embodying computer program code thereon for execution by a computer processor, wherein the computer program code comprises instructions for performing a method including the steps of receiving information related to a numerical range based at least on at least one uplink channel condition, and selecting a number of subband indices to include in a report based at least on the numerical range.

In accordance with an eighth aspect of the invention, an apparatus is provided which may include means for setting a numerical range for a number of subband indices that may be included in a report, and means for providing the numerical range for transmission.

In accordance with the eighth aspect of the invention, the apparatus may also include means for scheduling packets in response to the report.

In accordance with a ninth aspect of the invention, an apparatus is provided which may include means for selecting a number of subband indices to include in a report based at least on a numerical range for a number of subband indices, and means for generating the report using the number of subband indices.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a wireless communication system in which the present invention may be implemented, including a user equipment (UE) terminal and a NodeB or eNodeB of a radio access network (RAN).

FIG. 2 is a block diagram of the NodeB or eNode B of FIG. 1.

FIG. 3 is a block diagram of the UE terminal of FIG. 1.

FIG. 4 is a flow diagram of a method according to an aspect of the invention.

### DETAILED DESCRIPTION OF THE INVENTION

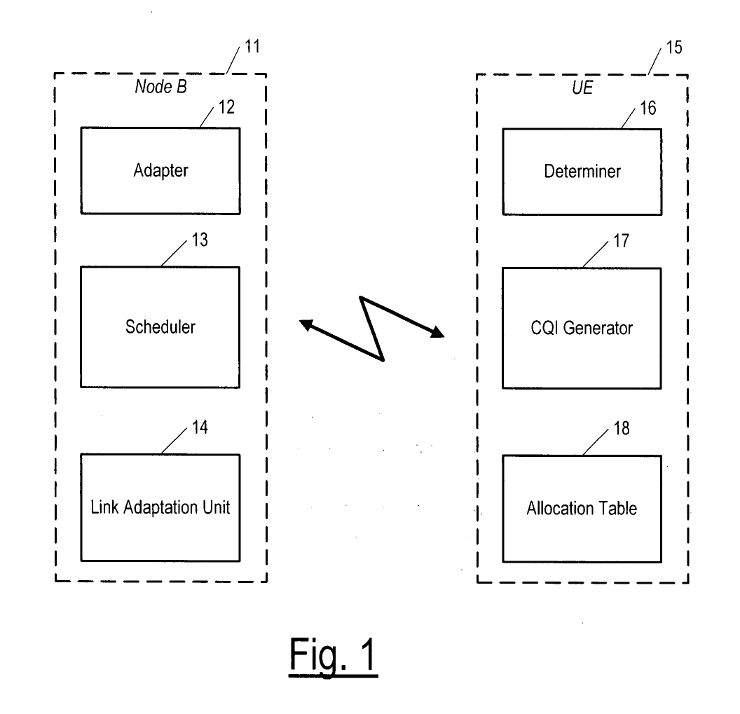

In an exemplary embodiment of the invention, as seen in FIG. 1, a network element, for example a NodeB or eNodeB 11, may include an adapter 12 configured to select a range (Mₘₐₓ to Mₘᵢₙ) of a number (M) of channel quality indices for sub-bands that a user equipment terminal 15 can utilize in generating a CQI report. The adapter 12 may be configured to select the range of M based on information specific to a particular user equipment terminal 15, or based on conditions present in the cell served by the Node B or e-Node B 11, i.e. on a per-cell basis. The range of M includes an upper limit (Mₘₐₓ), which indicates the maximum number (M) of channel quality indices for sub-bands that the user equipment terminal 15 may use in generating a CQI report, and a lower limit (Mₘᵢₙ), which indicates the minimum number (M) of channel quality indices for sub-bands that may be used.

In order to select the upper and lower limits of M the NodeB or eNodeB 11 makes assessments and/or observations on either a per-cell or a per-user equipment basis. For example, if the NodeB or eNodeB 11 determines that there is limited uplink capacity, and there is a need to limit the CQI reporting for each user equipment terminal 15, the adapter 12 may decrease the upper limit of M. However, decreasing the upper limit in some situations may limit the downlink capacity to an undesirable level, as a result of user multiplexing with more allocation table overhead. To compensate for this limitation on downlink capacity, the NodeB or eNodeB 11 may lower the reporting rate or frequency of the CQI reports, for example by increasing the reporting period or changing to event based signaling. In another example, the lower limit of M may be increased if only a certain number of users are being multiplexed. In this example, the user equipment terminal 15 may provide CQI reports with overlapping sub-bands, which may result in difficulty in scheduling decisions made by the NodeB or eNodeB 11. Therefore, it may be advantageous to increase the lower limit of M so that it is large enough for the NodeB or eNodeB 11 to the full spectrum for scheduling. In another example, if there are a certain number of users available for scheduling, the upper limit of M may be decreased and still allow for the provision of near optimum system performance. The foregoing examples are just some of the aspects which the adapter 12 may take into consideration when selecting the upper and lower limits of M.

Once the upper and lower limits of M are determined they are provided for transmission to the user equipment terminal 15. The upper and lower limits of M may be transmitted to the user equipment by means of direct signaling, for example higher layer radio resource control (RRC) signaling or dedicated physical layer signaling. As seen in FIG. 1, the user equipment terminal 15 may include a determiner 16 that is configured to select M, i.e. the number of sub-band channel quality indices to include in a CQI report generated by a CQI generator 17 of the user equipment terminal 15. In general, the value of M may be based upon the value that will provide the highest supported throughput for the user equipment terminal 15. For example, the value of M may be determined by sorting all of the available physical resource blocks (PBR) based on their signal-to-noise ratios (SNR), with the best SNR first indicating the highest quality physical resource block. Then the value of M is selected by the determiner 16, which incorporates the information from a certain number of PRBs and provides the highest supported throughput for the user equipment terminal 15.

The current setting for M may be updated for every CQI report. The selection of M by the determiner 16 may be based for example on the range of M provided by the Node B or e-Node B 11. In this manner, the determiner 16 selects a value of M that is within the upper and lower limit of M provided by the Node B 11. Since the user equipment terminal 15 may be able to semi-autonomously update M within a specified range, the amount of signaling between the Node B or e-Node B and user equipment with regard to the range of M is reduced since the range of M is unlikely to rapidly change. The selection of M may also be based on the history of resources block allocation to the user equipment. For example whether the user equipment had been allocated few or many resource blocks, whether the allocation is stable or variable. In this example, the user equipment terminal 15 can select a setting for M that most closely matches its real allocation, in order to assure the minimum required CQI signaling for the performance level achieved. In another example, the determiner 16 may use the available power budget for the user equipment in selecting M, or may also use the traffic load in the uplink when selecting M. These are merely provided as examples of factors that the determiner of the user equipment may use in selecting a value for M based on the current conditions.

Once the determiner has selected the value of M, the CQI generator generates 17 a best-M CQI report utilizing the allocation table 18 and the number (M) of indices of the best channel quality sub-bands. For example, if the value of M is five, then the CQI generator 17 uses the channel quality indices for the best five sub-bands to generate the best-M CQI report. In this manner, feedback information that is provided to the Node B 11 with respect to channel quality is based upon the strongest sub-bands. The best-M CQI report may then be transmitted to the eNodeB 11, where a scheduler 13 and link adaptation unit 14 of the eNodeB 11 conduct packet scheduling, for example frequency domain link packing scheduling (FDPS), and link adaptation, for example frequency domain link adaptation (FDLA) based on the best-M CQI report.

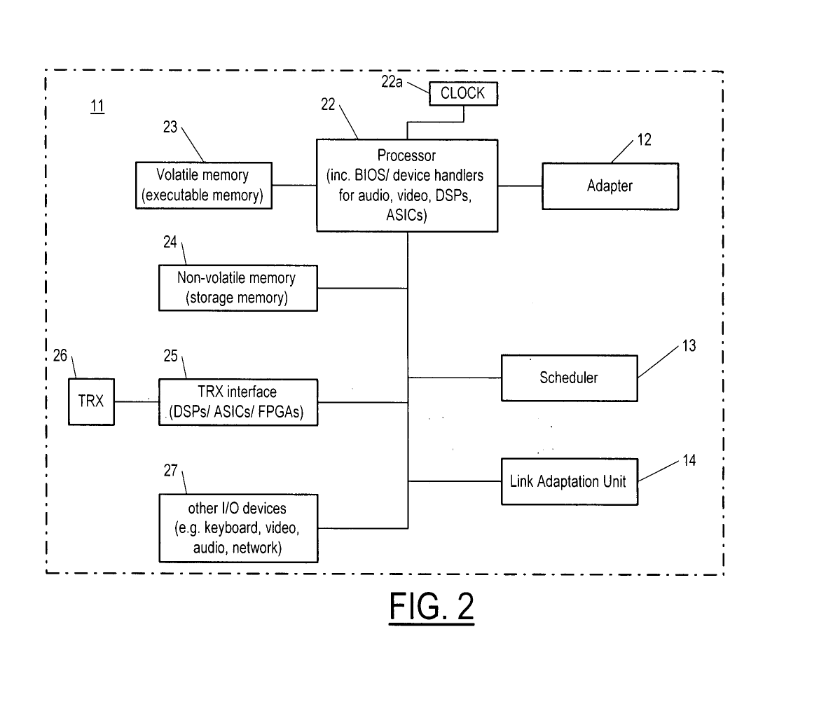

FIG. 2 shows some components of a network element, such as the NodeB or eNodeB 11 of FIG. 1. The NodeB or eNodeB 11 includes a processor 22 for controlling operation of the device, including all input and output. The processor 22, whose speed/timing is regulated by a clock 22a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 26 via a TRX interface 25 including possibly one or more digital signal processors (DSPs), application specific integrated circuits (ASICs), and/or field programmable gate arrays (FPGAs). The TRX enables communication over the air with another similarly equipped communication terminal.

Still referring to FIG. 2, the NodeB or eNodeB 11 includes volatile memory, i.e. so-called executable memory 23, and also non-volatile memory 24, i.e. storage memory. The processor 22 may copy applications (e.g. a calendar application or a game) stored in the non-volatile memory into the executable memory for execution. In an exemplary embodiment of the invention the NodeB or eNodeB 11 may also include an adapter 12 configured to select a range (Mₘₐₓ to Mₘᵢₙ) of a number (M) of channel quality of indices for sub-bands for the user equipment to utilize in generating a CQI report. The adapter 12 may be implemented as hardware or software, and may be configured to select the range of M based on current cell and/or user equipment conditions. The NodeB or eNodeB 11 may also include a scheduler 13 that is responsive to a CQI report received from user equipment, such as a best-M CQI report, for controlling packet scheduling in the downlink channel. The NodeB or eNodeB may also include a link adaptation unit 14, which may be responsive to the CQI report, for controlling link adaptation, such as the modulation and coding scheme used, in the downlink channel. It is understood that the elements of the network element discussed above may be separate elements or integrated into an element that performs the functions of the elements discussed above. Furthermore, it is understood that the one or more elements may be included or part of the processor 22, or another processing element. For example, the processor 22 may be configured to process or handle the selected range of M and/or configured to processor or handle the CQI report.

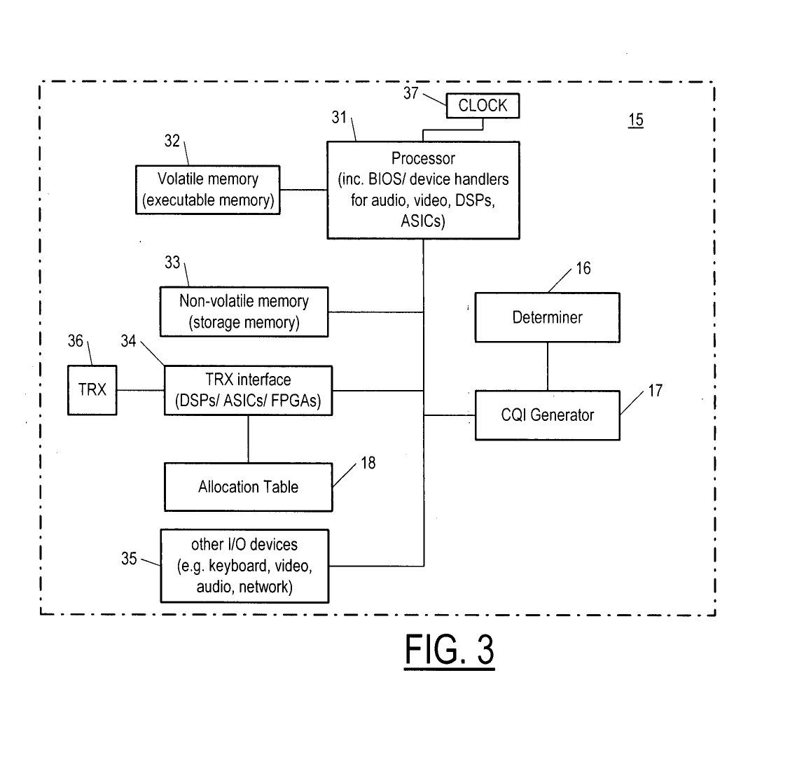

FIG. 3 shows some components of the user equipment terminal 15 of FIG. 1. The user equipment terminal 15 includes a processor 31 for controlling operation of the device, including all input and output. The processor 31, whose speed/timing is regulated by a clock 37, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 36 via a TRX interface 34 including possibly one or more digital signal processors (DSPs), application specific integrated circuits (ASICs), and/or field programmable gate arrays (FPGAs). The TRX enables communication over the air with another similarly equipped communication terminal. The user equipment terminal 15 may also include an allocation-table 18, which may contain the resource signaling from the Node B or e-Node B to the user equipment terminal 15.

Still referring to FIG. 3, the user equipment terminal includes volatile memory, i.e. so-called executable memory 32, and also non-volatile memory 33, i.e. storage memory. The processor 31 may copy applications (e.g. a calendar application or a game) stored in the non-volatile memory into the executable memory for execution. In an exemplary embodiment of the invention the user equipment terminal 15 may also include a determiner 16 configured to select the number (M) of sub-band channel quality indices to include in a CQI report. The determiner 16 may be implemented as hardware or software, and may be configured to select the number (M) based at least on the range of M provided to the user equipment terminal 15 by the NodeB or eNodeB 11. The user equipment terminal 15 may also include a CQI generator 17 configured to generate CQI reports, such as a best-M CQI report. The best-M CQI report includes the channel quality indices for M number of the user equipment terminal's best sub-bands. The CQI report values are derived based on common pilot channel (CPICH) transmissions by the NodeB or eNodeB. For example, if the value of M was 5 the CQI generator would use the channel quality indices based on the CPICH transmissions for the 5 best sub-bands in generating the best-M CQI report. It is understood that the elements of the user equipment terminal discussed above may be separate elements or integrated into an element that performs the functions of the elements discussed above. Furthermore, it is understood that the one or more elements may be included or part of the processor 31, or another processing element. For example, the processor 31 may be configured to process or handle the selected range of M and/or configured to processor or handle the CQI report.

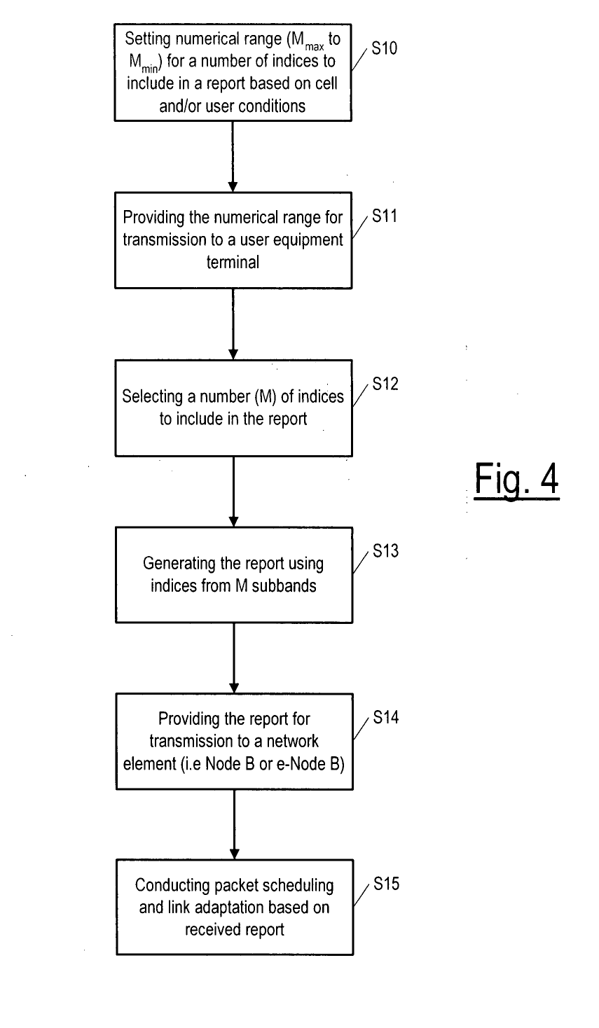

FIG. 4 shows steps that may be included in a method for carrying our an exemplary embodiment of the present invention. The method may include a step S10 of setting a numerical range for a number of indices to include in a report, such as a CQI report or a best-M CQI report, based on current cell and/or user conditions. The method may also include a step S11 of providing the numerical range for transmission, for example transmission to a user equipment terminal. The method may also include a step S12 of selecting a number (M) of indices to include in the report. The method may further include a step S13 of generating the report using indices from the selected number (M) of subbands. The method may also include a step S14 of providing the report for transmission to a network element, such as a NodeB or an eNode B. The method may also include a step S11 of conducting packet scheduling and link adaptation based at least in part on the received report.

The functionality described above (for both the radio access network and the UE) can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention can be provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention.

What is claimed is:

1. A method, comprising:
observing at least one uplink channel condition, and
setting a numerical range, based at least on the at least one observed uplink channel condition, of a number of subband indices for inclusion in a report.

2. The method according to claim 1, further comprising transmitting the numerical range to at least one user equipment terminal.

3. The method according to claim 1, further comprising receiving the report comprising the number of subband indices from at least one user equipment terminal, and scheduling at least one packet for transmission in response to the report.

4. The method according to claim 1, wherein the observed uplink channel condition is an uplink channel capacity, and the method further comprises decreasing an upper limit of the numerical range when the uplink channel capacity is limited.

5. The method according to claim 1, wherein the observed uplink channel condition is a number of user equipment terminals available for scheduling, and the method further comprises decreasing an upper limit of the numerical range when the number of users available for scheduling exceeds a threshold.

6. The method according to claim 1, wherein the observed uplink channel condition is a number of multiplexed user equipment terminals, and the method further comprises increasing a lower limit of the numerical range when the number of multiplexed user equipment terminals is less than a threshold.

7. The method according to claim 1, wherein the at least one observed uplink channel condition comprises at least one channel condition for at least one user equipment terminal within a cell.

8. The method according to claim 1, wherein observing at least one channel condition, and setting the numerical range occur in a network element.

9. A method, comprising:
receiving information related to a numerical range based at least on at least one uplink channel condition, and
selecting a number of subband indices to include in a report based at least on the numerical range.

10. The method according to claim 9, further comprising providing the report for transmission to a network element.

11. The method according to claim 9, wherein receiving information related to the numerical range and selecting the number of subband indices occur in a user equipment terminal.

12. The method according to claim 11, wherein selecting the number of subband indices to include in the report is further based on a number of resource blocks allocated to the user equipment terminal.

13. The method according to claim 11, wherein selecting the number of subband indices to include in the report is further based on an available power level for the user equipment terminal.

14. The method according to claim 9, wherein selecting the number of subband indices to include in the report is further based an uplink traffic load.

15. An apparatus, comprising:
an observation unit for observing at least one uplink channel condition, and
an adapter for setting a numerical range, based at least on the at least one observed uplink channel condition, of a number of subband indices for inclusion in a report.

16. The apparatus according to claim 15, further comprising an interface for transmitting the numerical range to at least one user equipment terminal.

17. The apparatus according to claim 15, further comprising a scheduler responsive to the report comprising the number of subband indices, for scheduling at least one packet for transmission in response to the report.

18. The apparatus according to claim 15, wherein the observed uplink channel condition is an uplink channel capacity, and the adapter is configured to decrease an upper limit of the numerical range when the uplink channel capacity is limited.

19. The apparatus according to claim 15, wherein the apparatus comprises a network element.

20. An apparatus, comprising:
a receiver for receiving information related to a numerical range based at least on at least one uplink channel condition, and
a determiner for selecting a number of subband indices to include in a report based at least one the numerical range.

21. The apparatus according to claim 20, further comprising a generator for generating the report using the number of subband indices.

22. The apparatus according to claim 21, wherein the apparatus comprises a user equipment terminal.

23. A system, comprising:
a network element comprising:
an adapter for setting a numerical range, based at least on at least one uplink channel condition, for a number of subband indices for inclusion in a report, and
a transmitter for transmitting the numerical range from the network element to at least one user equipment terminal,
wherein the at least one user equipment terminal comprises:
a determiner for selecting the number of subband indices to include in the report based at least on the numerical range for a number of subband indices, and
a generator for generating the report using the number of subband indices.

24. A computer program product comprising a computer readable storage structure embodying computer program code thereon for execution by a computer processor, wherein the computer program code comprises instructions for performing a method according to claim 1.

25. A computer program product comprising a computer readable storage structure embodying computer program code thereon for execution by a computer processor, wherein the computer program code comprises instructions for performing a method according to claim 9.
